(19) United States
(12) Patent Application Publication
(10) Pub. No.: US 2010/0252395 A1
(43) Pub. Date: Oct. 7, 2010

(54) Method for moving a material processing device, a device for processing mineral material, and a frame for a processing device

(75) Inventors: Harri Lehtonen, Pirkkala (FI); Tuomas Jokioinen, Tampere (FI); Matti Peltola, Tampere (FI); Timo Mustonen, Tampere (FI); Markku Pusenius, Tampere (FI); Antti Peltola, Pirkkala (FI); Harri Niemi, Tampere (FI)

Correspondence Address: OLIFF & BERRIDGE, PLC, P.O. BOX 320850, ALEXANDRIA, VA, 22320-4850, US

(73) Assignee: Metso Minerals, Inc., Helsinki (FI)

(21) Appl. No.: 12/735,078

(22) PCT Filed: Dec. 19, 2007
(86) PCT No.: PCT/FI2007/050712

§ 371 Date: Jun. 18, 2010

(51) Int. Cl. B62D 57/032; B65G 41/00; B07B 1/00; B24B 41/00

(52) U.S. Cl. 198/300; 180/8.6; 209/261; 241/285.1

(57) ABSTRACT

A method for moving a processing device, a frame of a processing device and a processing device, which is moved on a base. The processing device comprises at least one processing unit and a frame, to which the processing unit is attached, as well as at least four legs articulated to the frame. The legs comprise support plates settable against the base. The legs are settable into a support phase, where the support plate settles against the base and into a transfer phase, where the support plate is off the base. The processing device is moved without lowering the frame onto the base so that the legs are controlled to settle to the support phase and the transfer phase alternately so that at least three legs are in the support phase when the processing device moves.

### FIELD OF THE INVENTION

The invention relates to a method for moving a material processing device according to the preamble of the appended claim 1. The invention also relates to a device for processing mineral material according to the preamble of the appended claim 13, as well as a frame for a processing device according to the preamble of the appended claim 24.

### BACKGROUND OF THE INVENTION

Processing devices for mineral material are typically used for feeding, conveying, crushing, screening or washing mineral materials. Typically such a processing device comprises a frame and at least one processing unit suitable for processing mineral materials, for example a feeder, a belt conveyor, a crusher, a screen, or a corresponding device for transferring, refining or sorting mineral material. Often two or more processing units are integrated in the same frame, thus attaining a device suitable for versatile processing of mineral material.

Often such processing devices for mineral material are designed so that they can be transported between different working sites or at least within one working site. Thus, the frame of a processing device for mineral material is often provided with runners, wheels or tracks. Mineral material processing devices are often also provided with an independent power source, for example a diesel motor that is connected to wheels or tracks underneath the frame, thus attaining a transferrable device that is capable of moving independently.

When a new transferrable processing device for mineral material is designed, some objectives of the design work are, in addition to the processing efficiency and productivity, the easy and safe transferability of the processing device. These objectives are often contradictory, and the designers must resort to compromises. For example, a high productivity requires the use of productive, large-sized processing units in the processing device for mineral material. However, the use of such units makes the entire processing device large in size and difficult to transfer not only inside the working site, but also between different working sites.

Finnish patent publication F1109662 (corresponding U.S. Pat. No. 7,004,411) discloses a mobile processing device for mineral material, in which the processing units include a vibrating feeder, a jaw crusher, two belt conveyors and a magnetic separator. The device comprises a power source of its own, as well as tracks connected to the frame of the device, with which tracks the unit can be moved in a working site between different destinations.

Moving a track-mounted processing device for mineral materials on a working site is difficult. The processing device cannot be moved sideways, but transferring it sideways requires several forward and backward movements of the entire processing device. Similarly, even a small change in the position of the front or back end of the frame requires forward and backward movements of the entire processing device.

In addition, the suitability for terrain of a track-mounted processing device for mineral materials is poor, because it must go around different obstacles on the terrain, and therefore, it moves slowly in the working site. Thus, transferring the processing device from one location to another takes a long time.

When tracks or wheels are used for moving a device for processing mineral material, the frame of the processing device must be such that the tracks or wheels can be attached to it, and that the device keeps its balance both when it is moved and used. This type of a frame structure limits the placement of parts of the processing device to be attached to the device and/or the frame, such as, for example, conveyors.

In addition, solutions are known, where the processing device for mineral material is transferred in a working site with different leg-like transfer means. In U.S. Pat. No. 4,324,302 one leg has been mounted under the frame supporting the crusher, which leg comprises one vertically mounted first hydraulic cylinder. In addition, two other hydraulic cylinders are connected to the leg, which cylinders move the first hydraulic cylinder forwards and backwards, as well as sideways in relation to the frame. When transferring the crusher, its frame is slid by means of the leg along a base.

In U.S. Pat. No. 3,446,301 one leg for moving the crusher has also been mounted on the frame supporting a heavy device, such as a crusher or a conveyor. The leg comprises five vertically mounted first hydraulic cylinders, which are used for lifting the frame off the ground. In addition, four pairs of vertically acting hydraulic cylinders are connected to the leg, which cylinders move the leg forwards and backwards, as well as sideways in relation to the frame. The device is moved one step at a time by lifting the frame of the device off the ground and by moving it in the air for a transfer distance defined by the leg in the desired direction and by lowering the frame back to the ground.

DE publication 6601257 discloses a solution suitable for moving a crusher, where one leg based on a hydraulic cylinder is mounted to the frame of the crusher. In another disclosed embodiment there are three legs. Moving the crusher takes place one step at a time by transferring the frame a small distance at a time in the desired direction. The frame is lifted off the ground and lowered back down again at each step.

Transferring a heavy device by means of one leg is discontinuous, which slows down and complicates moving. The device must be lowered onto the ground between each step and the frame must be slid along the ground. The device is not suitable for terrain, but potholes and protrusions of the terrain can prevent the device from moving completely.

In addition to the solutions presented above, other devices for moving heavy working machines and loads are known, which devices comprise several hydraulically functioning legs. The vertical lengthening and shortening of the legs, as well as their movement sideways is implemented by hydraulic cylinders. This kind of devices are disclosed, for example, in patent publications U.S. Pat. No. 3,638,747, GB2017605 and DE 2129197. Moving the device takes place either by sliding it on the ground or by steps, where the frame is lifted off the ground and transferred for a short distance and then the frame is lowered back onto the ground. This uses unnecessary energy. Another problem of these solutions is that transferring the device is slow and complicated. In addition, GB publication 1368050 shows a kind of a stepping mechanism for moving machines.

### BRIEF SUMMARY OF THE INVENTION

It is therefore an aim of the present invention to provide a device for processing mineral material, which avoids the above-presented problems and which can be moved from one place to another in a working site easily, fast and accurately, and without requiring extra movements. It is also an aim of the invention to provide a method for moving a device for processing material. Further, a purpose is to provide a frame for a processing device.

To attain this purpose, the method according to the invention is primarily characterized in what will be presented in the characterizing part of the independent claim 1.

The processing device according to the invention, in turn, is primarily characterized in what will be presented in the characterizing part of the independent claim 23.

The frame for a processing device according to the invention, in turn, is primarily characterized in what will be presented in the characterizing part of the independent claim 24.

The other, dependent claims will present some preferred embodiments of the invention.

The invention is based on the idea that legs mounted to a processing device for mineral material are used for moving the device, by means of which legs a movement resembling walking is created. When the processing device is transferred, the frame of the device, together with the devices attached to it, is lifted off the ground by means of legs. The legs carry the entire weight of the device and at the same time move the device. The legs are controlled so that the movement of the device resembles walking. At least four legs are attached to the frame of the processing device; preferably there are six or more legs. The legs are positioned in relation to the perimeter of the frame so that a steady and continuous movement of the device without lowering the frame onto the ground during movement, between steps, is possible.

The legs comprise three transfer members. The first transfer member is vertically articulated to the frame of the processing device and it takes care of adjusting the length of the leg and its vertical movement. The second and third transfer member, which are attached to the first transfer member at their one end, and to the frame of the device at their other end, create the sideways movements of the legs. In addition, measuring means are arranged in each leg for determining the angle between the first transfer member and the frame of the processing device and the position of the support plate of the leg touching the ground. In addition, the pressure caused by the support plate against a base is measured substantially continuously. The attachment angle of the second and third transfer members to the first transfer member is arranged so that the leg can be moved in any direction. This means that the directions of movement of the processing device are not limited in any way.

When the processing device is moved, the legs carry the entire weight of the device and at the same time move the device. If the device is in a working position resting by the frame on a base, the frame of the device together with the devices connected to it is lifted off the ground by means of legs before moving it. During movement the legs are moved according to the selected walking mode, which is affected by the number of legs mounted to the device and the direction of movement and the desired speed of movement provided to the device by the user of the device. In the walking mode a part of the legs are in a support phase, i.e. touching the ground, and a part in a transfer phase, i.e. in the air. The legs in the transfer phase are moved towards a new position on the base and they are lowered onto the base, i.e. ground to their new position. The movement of the legs in the transfer phase can take place at different times with respect to each other, or the movement can be simultaneous, in which case, for example, two legs are moved at the same time. The step height of the legs, i.e. how much the leg is lifted when taking a step, can also be adjusted. This adjustment can, if desired, be made separately for each leg in the transfer phase.

The frame according to the invention can be utilized in moving such processing devices or units that are separate from the frame, which do not themselves comprise means for moving the device. This takes place, for example, so that the processing device is moved on top of a frame comprising legs and attached to it, after which the device can be moved by the legs to a desired location.

An advantage of the invention is that the processing device can be easily moved in all directions, sideways and cornerwise as well. In addition to this, the device can be rotated around any arbitrary point. This point can be located, for example, in the midpoint of the device, in the material loading or discharge end of the device, or even outside the device.

In addition, an advantage of the invention is that the processing device can be moved significantly faster and easier than with transfer means according to prior art. The frame is not lowered down between steps, but the movement is continuous. Thus, the movement is steady and energy is also saved. The terrain-suitability of a walking processing device is also better than, for example, that of a track-mounted processing device. By means of sensors arranged in the legs the length of the legs and their contact to the ground can be monitored, in which case the potholes and roughness of the ground can be compensated by adjusting the length of the leg and the device can be kept in balance. With adjusting the length of the leg the processing device can be kept in balance, i.e. the frame is substantially horizontal even when it is moving up or down a slope.

An advantage of the invention is that with the legs the processing device can be tilted for maintenance. Thus, access from under the frame to processing units attached to it, such as a crusher or a feeder, becomes easier.

In addition, the legs improve the stability of the processing device when the processing device is running, because the legs can be used to support the processing device. When using the processing device, it can be supported off the ground with the legs. Thus, in addition to movement, the legs affect adjusting the position of the device and they affect the functionality of processing, such as, for example, crushing or screening. The device can be actively maintained in a predetermined position, for example in horizontal position, during moving or crushing by adjusting the length of the legs if the terrain is uneven. The processing device can also be lowered to the ground to rest on the frame in a working position. At least a part of the legs can also be lowered to the ground, in which case they support the device. Especially the legs at the front or back end of the frame, or close to the ends, can be utilized as supporting legs. In addition, it is not necessary to stop the processing device for moving the device, but the device can continue its operation without breaks. This is especially advantageous when the device is moved only a small distance or when the device is to be repositioned, for example, by moving only its front or back end.

By adjusting the length of the legs it is also possible to adjust the ground clearance of the processing device, in which case its movement on uneven terrain is easier.

In addition, an advantage of the invention is that each leg is a separate unit independent of the other legs. This provides freedom both to the design of the frame and the placement of the processing devices. The legs can be placed to the frame easily and there are more possibilities for the placement of the processing devices.

### BRIEF DESCRIPTION OF THE DRAWINGS

In the following, the invention will be described in more detail with reference to the appended drawings, in which

FIG. 1 shows a schematical side view of a processing device for mineral material comprising legs for moving the device,

FIG. 2 shows the processing device of FIG. 1 from below,

FIGS. 3a and 3b show schematically different options for the placement of legs in a frame of a processing device,

FIGS. 4a to 4f show some directions: of movement of a processing device,

FIG. 5 shows schematically a hydraulic leg in a front view,

FIG. 6 shows the leg of FIG. 5 in a top view;

FIG. 7 shows a control unit in a schematic view, and

FIGS. 8a to 8d show the different phases of moving a processing device in a perspective view.

### DETAILED DESCRIPTION OF THE INVENTION

In this description a processing unit refers to any processing unit suitable for processing materials, such as a feeder, a belt conveyor, a crusher, a screen, or a corresponding device for transferring, refining or sorting material. Processing units used in recycling material, such as shredders and metal separators, belong to this group as well. The material being processed can be mineral material. The mineral material can be ore, broken rock or gravel, various types of recyclable construction waste, such as concrete, bricks or asphalt. The material can also be domestic waste, as well as wood, glass or metal.

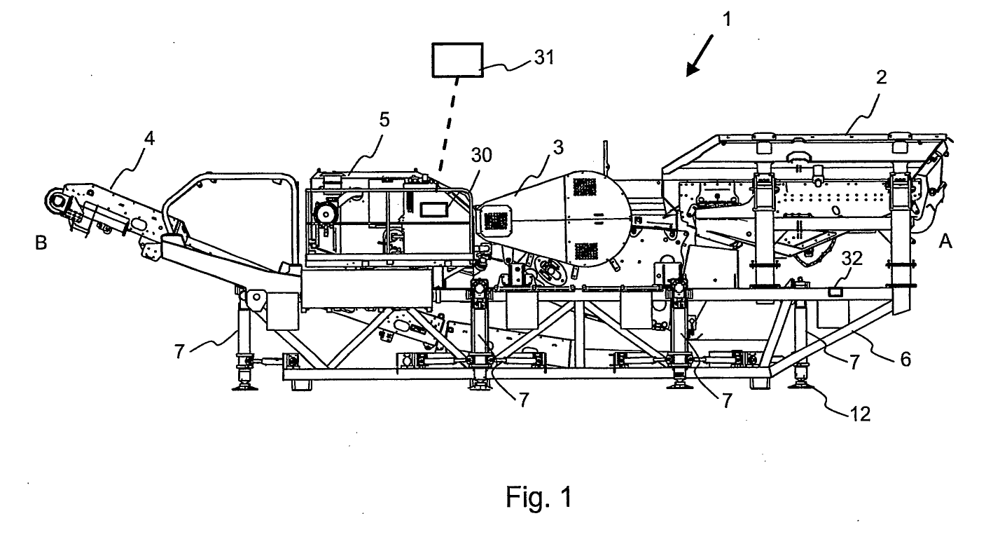

FIG. 1 shows a processing device 1 for mineral material comprising a feeder 2 for feeding material to a crusher 3 and a belt conveyor 4 for conveying the crushed product further away from the device. The crusher in the figure is a jaw crusher, but other types of crushers, such as a gyratory crusher, a cone crusher or a centrifugal crusher can be placed as parts of the processing device. In addition, the device comprises a power source 5, such as a diesel motor, which produces energy for the use of processing units.

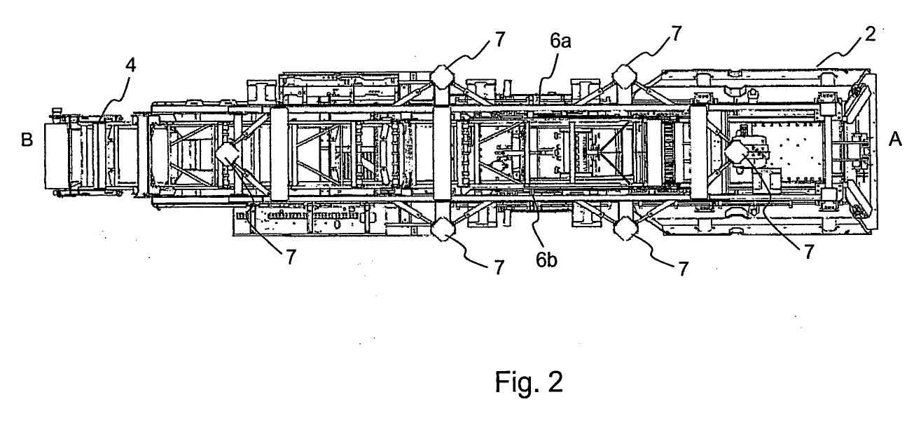

The feeder, crusher, power source and conveyor are attached to a frame 6. Legs 7 for moving the device are also attached in an articulated manner to the frame 6. In this embodiment there are six legs 7, as is shown in FIG. 2 as well. FIG. 2 shows the processing device from below, without the conveyor belt of the conveyor. The legs 7 are attached to the frame in relation to the center of gravity so that the frame 6 is substantially horizontal when the device is moved. The legs are placed in the frame 6 in relation to the processing device 1 so that one leg is in the front end A of the device, i.e. below the feeder 2, and one leg is in the back end B of the device, i.e. below the conveyor 4. The remaining four legs are placed on both sides of the frame in pairs so that the legs on opposite sides of the frame are at the same point in relation to the length of the frame. As can be seen in FIGS. 1 and 2, the legs 7 attached on the long sides 6a and 6b of the frame are attached on the outside of the frame. In an embodiment of FIG. 1 the processing device 1 is shown in a working position, where the frame is lowered onto a base, i.e. on the ground and the support plates 12 of the legs 7 have also been taken to the ground to support the device. In addition, the device comprises a control unit 30, whose operation is described more in detail later.

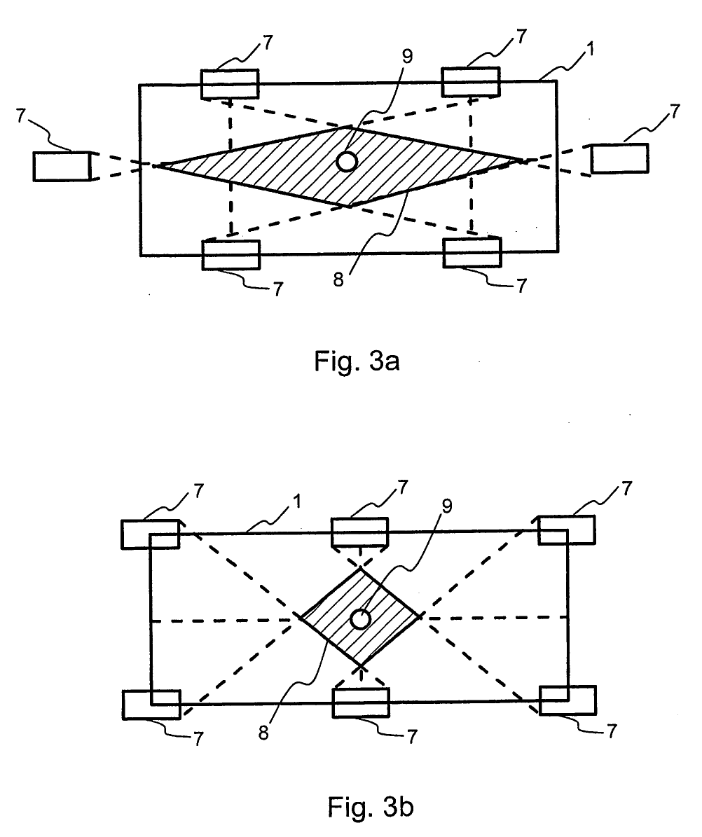

When placing the legs onto the frame, it must be taken into account that the processing devices, for example side conveyors (not shown in the figures) can be attached to the frame. In addition, it must be taken into account that the legs are around the center of gravity. In addition, from the point of view of movement it is important that the stability marginal located around the center of gravity of the device is as wide as possible. The stability marginal describes an imaginary planar surface, inside which the center of gravity of the processing plant may vary during movement in order to keep the device in balance and to prevent it from falling over. FIGS. 3a and 3b show schematically the different possibilities of placing legs 7 in a device and the stability marginals 8 created on the basis of that. FIG. 3a shows the placement of legs 7 according to FIGS. 1 and 2. As can be seen from the figure, with this placement a large stability marginal 8 around the center of gravity 9 is created. This increases the efficiency of movement of the device, especially when moving sideways. The stability marginal is especially increased by the placement of one leg at both the front end A and the back end B of the device in order to receive the load weights caused there. FIG. 3b shows another embodiment where the legs 7 are placed in pairs on both sides of the device 1 so that the legs on opposite sides of the frame are at the same point in relation to the length of the device. The stability marginal of this alternative is not as large as in the embodiment of FIG. 3a. It is, however, enough for moving the device from one location to another without the danger of losing the balance of the device.

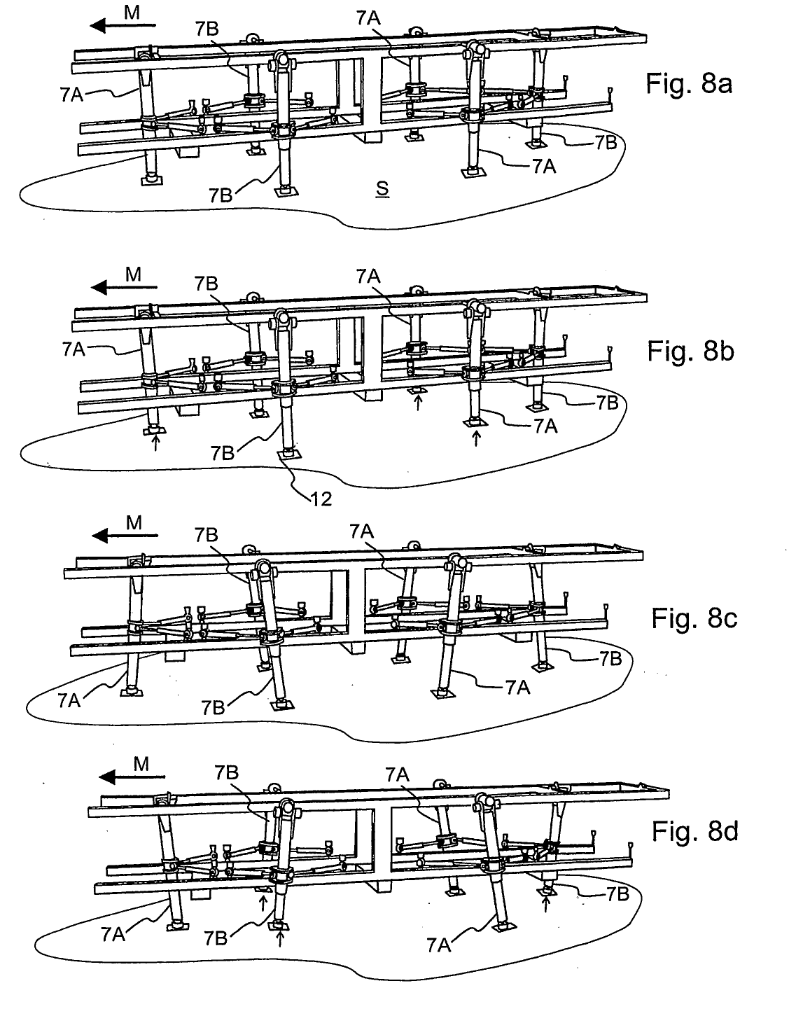

When transferring the processing device a part of the legs is always in a support stage, i.e. touching the ground, and a part in a transfer phase, i.e. off the ground and moving towards a new position. The predefined plan that defines how many legs are in the support and transfer phases is called a walking mode. For example, the possible walking modes of a processing device comprising six legs are a 5/6 mode, a 4/6 mode and a 3/6 mode. The first number refers to the number of legs in the support phase and the second number to the total number of legs. Thus, in the 5/6 mode the device comprises six legs, five of which are in the support phase, i.e. only one leg at a time is off the ground and moving towards a new position. In the 4/6, mode four legs are in the support phase and two legs in the transfer phase. Correspondingly, in the 3/6 mode three legs are in the support phase and three legs in the transfer phase. The greatest speed of moving is reached by this walking mode. If at least two legs are in the transfer phase, the movement of the legs can take place at different times with respect to each other, or the movement can be simultaneous. For example, the legs can move simultaneously in pairs. However, there must always be at least three legs in the support phase. Support and transfer phases follow each other at each leg. The legs in the support phase not only keep the device in balance, but also move the frame of the device to the desired direction. The legs in the transfer phase move in the air according to a path and direction of movement defined for them, until they are again lowered to the ground and they transfer to the support phase. During movement the legs are moved according to the selected walking mode. The selection of the walking mode is primarily affected by the difficulty of the terrain, but also the number of legs and the desired speed of movement. The movement and the alternation of the support and transfer phases of the legs are described more in detail in connection with FIGS. 8a to 8d.

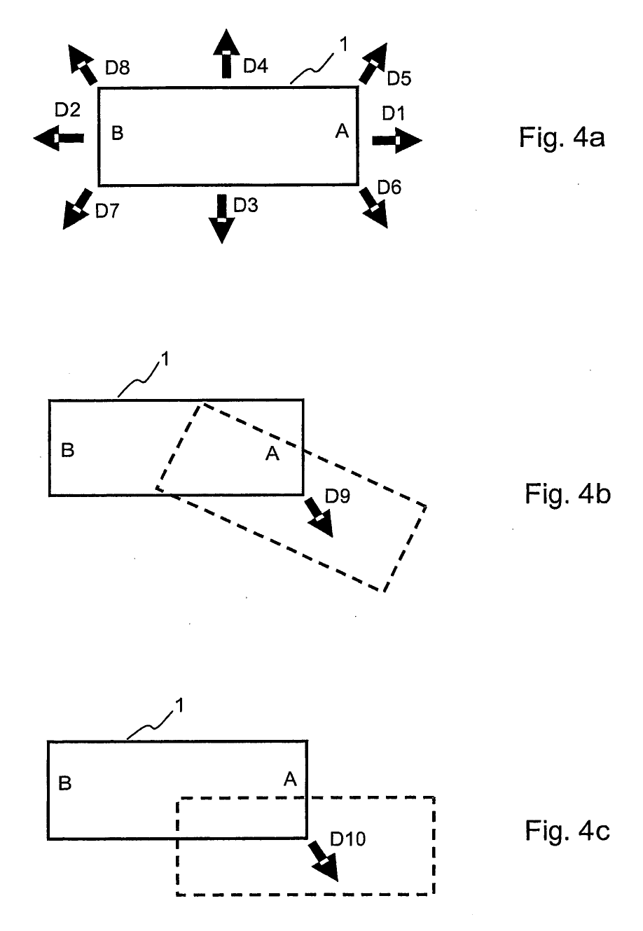

The processing device can be transferred to various directions. FIGS. 4a to 4f show some examples of the directions of movement of the processing device. The processing device 1 can naturally be transferred forward, in the direction of arrow D1, and backward, in the direction of arrow D2, as shown in FIG. 4a. Transfer in both side directions is also possible. This is shown by arrows D3 and D4. Transfer of the device forward and backward in the direction of its corners is shown by arrows D5, D6, D7 and D8. It is also possible to transfer the device 1 so that the device moves in the desired direction and it is turned at the same time, as shown in FIG. 4b. The direction of movement is shown by arrow D9 and the new position of the device is shown by dashed lines. FIG. 4c shows the direction of movement, where the device moves to the desired direction so that the frame is not turned, but it is kept in the starting direction the entire time. This walking can also be called crab walking. The direction of movement is indicated with arrow D10. Transfer according to FIGS. 4b and 4c can take place in all directions shown in FIG. 4a.

The processing device 1 can also be transferred or its position can be changed by turning it freely around a selected point. The freely selectable point 34 can be located anywhere inside or outside the bottom area of the device. It can be, for example, the center of the device, around which the device is turned. This is illustrated by arrows D11 in the FIG. 4d. In FIG. 4e a freely selectable point 34 is placed inside the bottom area of the device 1 and the possible turning directions of the device are illustrated by arrows D12. The freely selectable point 34 can also be placed outside the device, as is shown in FIG. 4f. The arrows D13 show the turning directions of the device. All the above-presented directions of movement and turning alternatives can naturally be combined as desired.

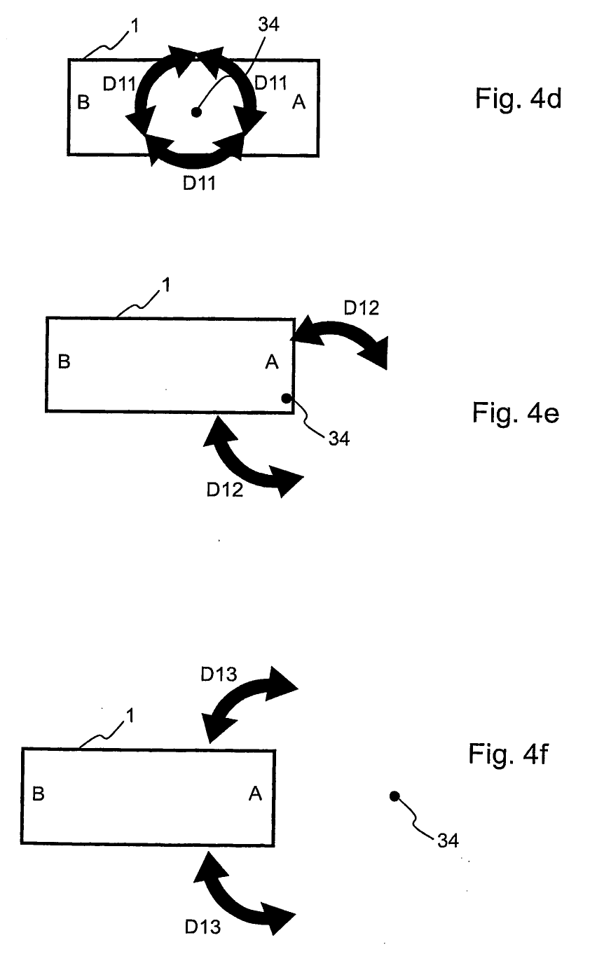

FIG. 5 shows a leg 7. This type of legs are also arranged in the processing device shown in FIGS. 1 and 2. The leg 7 comprises three transfer members 10, 14 and 15, which are rigid in relation to their longitudinal axis. In this embodiment the transfer members are hydraulic cylinders, but other longitudinally adjustable transfer members can also be used. The longitudinal movement can be created, for example, with a worm screw and an electric motor. This kind of an arrangement is called an electric cylinder as well.

The first hydraulic cylinder 10 is vertically attached in an articulated manner to the frame of the processing device. It is possible to adjust the length of the leg by means of it. It also carries the vertical forces and the weight of the processing device when the processing device is moved or when the leg acts as a support leg when using the device. In the figure the first hydraulic cylinder 10 is shown in a position where a part of a transfer arm 11a of the cylinder is outside a cylinder chamber 11. A support plate 12 is attached to the lower end of the transfer arm. 11a of the first cylinder 10, the lower surface of which plate, i.e. a support surface 13 touches the ground when the leg 7 is in the support phase. The support surface 13 can have, for example, a square-like shape with side lengths of 350 mm×350 mm. The area of the support surface is dimensioned according to the type of base of the working site. The weight of the processing device is also taken into account in the dimensioning. The support plate 12 is attached to the end of the transfer arm of the first hydraulic cylinder with a fastening means 12a, which enables the tilting of the support plate in relation to the transfer arm. For example, a ball joint can be used as the fastening means. The first cylinder is articulated to the frame 6 of the processing device by means of a first articulation 20 and a second articulation 21 arranged in the upper end of the cylinder chamber 11. The second and third hydraulic cylinder 14 and 15 are articulated to the first hydraulic cylinder 10 substantially horizontally and on the same level with each other. The transfer arms 16 and 17 of the second hydraulic cylinder 14 and the third hydraulic cylinder 15 are attached by means of a third articulation 22 and a fourth articulation 23 to the lower part of the cylinder chamber 11 of the first hydraulic cylinder, within a distance from the lower end of the cylinder chamber. Their ends on the side of the cylinder chamber 18 and 19 are, in turn, articulated to the frame 6 of the processing plant by means of a fifth articulation 24 and a sixth articulation 25. The second and third hydraulic cylinder 14, 15 create the sideways movements of the leg 7. The movement of the leg 7 created by the hydraulic cylinders 14 and 15 comprises both a horizontal and a vertical component, whose size, varies depending on the desired path of movement of the leg. In other words, the path of movement of the support plate 12 can be arch-like or take place only on the horizontal plane. The first hydraulic cylinder 10 is larger in size and in its cylinder capacity than the second and third hydraulic cylinder 14 and 15.

Measuring means, i.e. sensors, are arranged in the leg 7, for defining the position of the leg and the position of the support plate 12 substantially continuously. In connection with the first hydraulic cylinder, in its upper end, or, for example, inside articulations 20 and 21 are arranged first measuring means, i.e. two angle sensors 26 and 27, with which the angle position of the hydraulic cylinder 10 in relation to the frame 6 is measured. In addition, a second measuring means 28, such as a linear sensor for measuring the vertical position of the support plate 12 in relation to the frame, is arranged in the first cylinder. Thus, the linear sensor measures the magnitude of the vertical movement of the first cylinder 10. For example, a magnetostrictive sensor can be used as a linear sensor. The second measuring means can also be an optical measuring means, such as a measuring device based on a laser or image processing. In addition, measuring devices based on acoustic methods as well as magnetic field measuring, such as an ultrasound sensor or an eddy current sensor, can be used. With these three sensors 26, 27 and 28 the position of the support plate 12 in relation to the frame can be defined.

Measuring means 38 and 39 arranged in the hydraulic cylinders 14 and 15 can also function as first measuring means, which may have the same measuring principle as the above-mentioned measuring means 28. By means of them the length of at least one of the hydraulic cylinders 14 and/or 15 is measured, from which length it is possible to determine the angle position of the hydraulic cylinder 10 and further the position of the support plate 12 in relation to the frame.

The pressure prevailing in the cylinder chamber of the first hydraulic cylinder 10 is measured as well. The measurement takes place by means of a pressure sensor 29. On the basis of pressure measurements it is possible to determine the pressure caused by the support plate 12 against the base and to ensure that the force the support plate 12 touches the ground with is sufficient. The sensors perform measurements substantially continuously and by means of the measurements the position of the support plate 12 in both the transfer and support phases can be determined continuously. In addition, the position of the frame in relation to the base is measured with an inclination sensor 32. The inclination sensor can be, for example, an inclinometer. The measuring signals measured by the sensors are sent to a control unit 30 placed in the processing device. The control unit 30 controls the movement of the processing device according to commands provided by the user of the processing device, which commands are sent to the control unit 30 with a user interface 31 connected to it. The user interface can be, for example, a joy-stick-type interface based on wireless signal transfer, or a keyboard. Thus, a transmitter is arranged in the user interface for transmitting control commands to the control unit, and a receiver is arranged in the control unit for receiving them. In the figure the wireless data transfer is illustrated by a dashed line. In addition, the user interface 31 may be connected to the control unit 30 by a cable.

The measurement signals measured by the measuring means, i.e. the angle sensors 26 and 27, the linear sensor 28, the pressure sensor 29 and the inclination sensor 32, can be directed to the control unit 30 either via cables or wirelessly. If the measurements are transmitted to the control unit wirelessly, the measuring means are provided with a transmitter for transmitting measurement results, and the control unit is provided with a receiver for receiving measurement signals. The control unit forms control commands for moving the hydraulic cylinders of the legs on the basis of the measurement signals and other control parameters. The control commands produced by the control unit can also be conveyed to the legs either via cables or wirelessly. If the control commands are transmitted to the legs wirelessly, such as via radio waves or infrared radiation, the control unit is provided with a transmitter for transmitting control commands and the legs are provided with a receiver for receiving control commands.

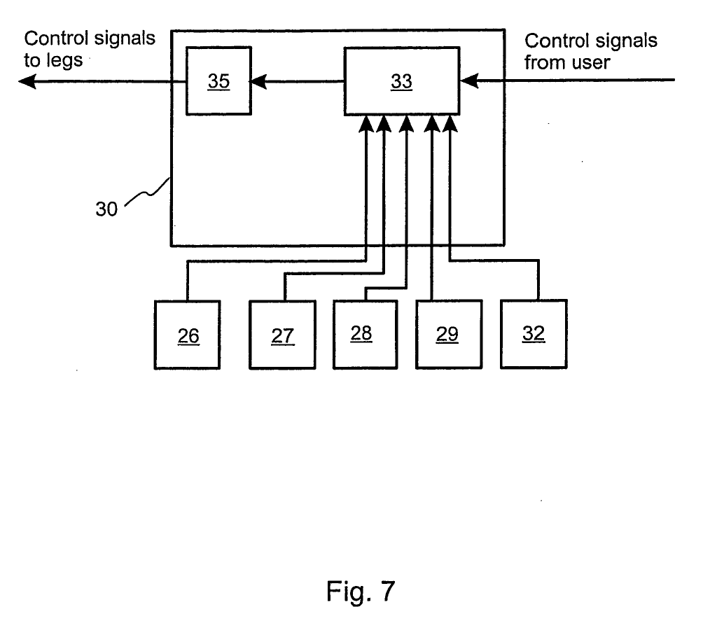

The control unit 30 comprises means for performing the operations of the method according to the invention. FIG. 7 shows more closely a control unit 30, which includes means 33 to 35 for calculating and determining the parameters necessary for moving the process device, as well as for determining the control signals. The steps of the above-described method can be performed by a program, for example by a micro processor. The means may be composed of one or more microprocessors and the application software contained therein. In this example, there are several means, but the different steps of the method can also be performed in a single means.

The control unit 30 comprises calculating means 33, which receive the data concerning the desired walking mode and the direction and speed of movement of the processing device sent by the user of the processing device. The calculating means 33 also receive the measurement signals measured by the measuring means 26, 27, 28, 29 and 32 and on the basis of them and the selected walking mode they calculate a step diagram for each leg 7 and on the basis of that determine their next path and direction of movement. Determining the path and direction of movement of the legs also takes into account the so-called step box, i.e. a cubic capacity in square space, where the support plate 12 can move within the limits set by the cylinders.

The paths and directions of movement determined for each leg by the calculating means 33 are transmitted to control signal formation means 35 in the control unit, which means form control commands for each hydraulic cylinder 10, 14 and 15 of each leg 7. After this, the control commands are sent to the valves (not shown in the figure) controlling the hydraulic cylinders 10, 14 and 15.

The means 33 and 35 contained by the control unit perform the procedures designated for them continuously while the processing device moves. The control unit receives data from the measuring means on the position of each support plate in relation to the frame and continuously controls the movement of all legs according to the selected walking mode so that the targets for the direction of movement set by the controller of the device are realized. The processing of measurement signals can be performed in a centralized manner with one control unit.

As was stated above, the control unit 30 comprises means for controlling the movement of the legs. The control unit may also comprise means for controlling the process itself, such as the operation of a crusher, conveyor or the like.

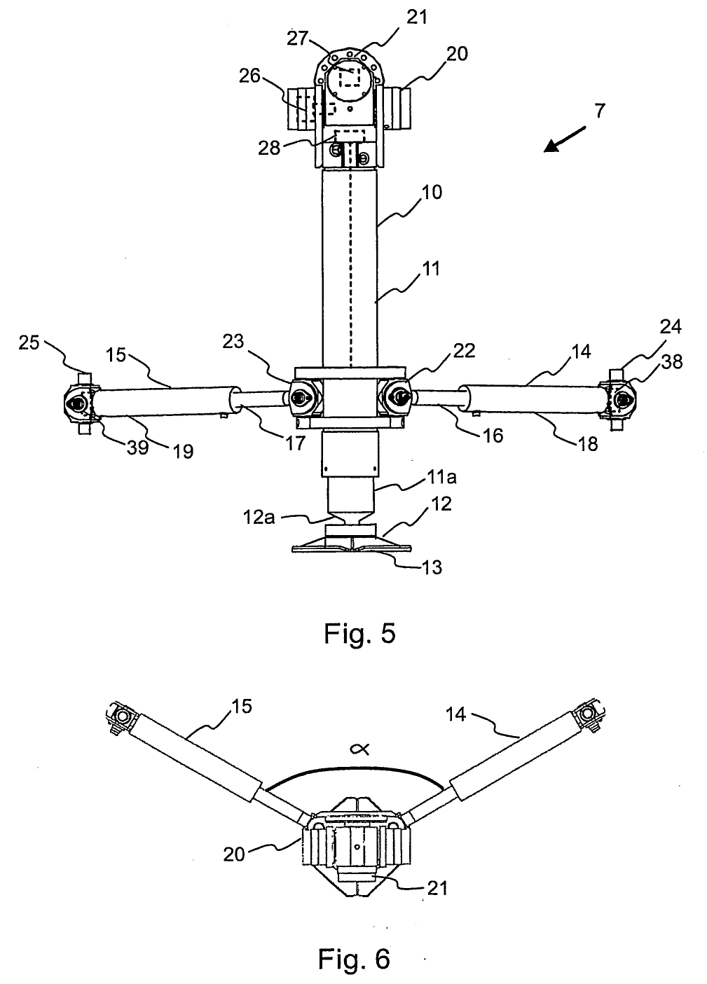

FIG. 6 shows the leg 7 of FIG. 5 in a basic position seen from above. As can be seen in the figure, the second and third hydraulic cylinders 14 and 15 are attached to the first hydraulic cylinder 10 so that an angle α is formed between them. The size of the angle α depends on several factors, for example, on the fastening point of the cylinders 14 and 15 to the frame 6, the dimensions of the processing device, the length of the cylinders 14 and 15, and the diameter of their cylinder chambers, as well as the required horizontal powers. These factors are selected so that the desired step box is created.

When taking a step, the hydraulic cylinders of the leg in the transfer phase operate in the following manner: first, the support plate 12 of the leg is lifted off the ground by means of the first cylinder 10, by pulling the transfer arm 11a of the first cylinder inside the first cylinder chamber 11. How high the support plate 12 of the leg is lifted depends on the desired height of the step. After this the second and/or third cylinder 14 and 15 move the first cylinder 10 to the desired direction by pushing and/or pulling the transfer arms 16 and 17 of the cylinders from the cylinder chambers/to the cylinder chambers 18 and 19, until the desired direction of the step is reached. Finally, the first hydraulic cylinder lowers the support plate 12 of the leg back to the ground by pushing the transfer arm 11a of the first cylinder outwards from the first cylinder chamber. Naturally the operations of the first hydraulic cylinder and the second and/or third hydraulic cylinder can take place simultaneously as well. The legs in the support phase move the frame of the processing device towards the desired direction continuously; it is not lowered to the ground between steps. The length of the step, and at the same time the transfer speed of the device is controlled with the control system.

The movement and the alternation of the support and transfer phases of the legs are described more in detail in connection with FIGS. 8a to 8d. For clarity, the processing device is not shown in the figure. Six legs 7 are attached to the frame and the movement takes place in a 3/6 walking mode. In FIG. 8a the device is shown in the starting position, where all the legs are on the base S, i.e. on the ground.

In FIG. 8b a part of the legs, i.e. the legs 7A in the transfer phase are lifted off the ground. The legs 7B in the support phase are still on the ground. The desired direction of movement is indicated with the arrow M.

Next, the legs 7A in the transfer phase are tilted in the air against the direction of movement and moved towards the ground. Simultaneously the legs 7B in the support phase move the frame 6 in the determined direction of movement, which is marked with the arrow M. FIG. 8c shows the phase where the support plates 12 of the legs 7A have already reached the ground.

When the supporting plates 12 of the legs 7A have again been lowered to the ground and it has been ensured that the device is in balance, the legs 7A transfer to the support phase and the legs 7B that were previously in the support phase transfer to the transfer phase. Thus, two things take place simultaneously: the legs 7A are straightened to a position perpendicular to the surface of the ground and are tilted towards the direction of movement, simultaneously moving the device towards the direction of movement. At the same time the legs 7B begin to rise, straighten and further tilt and lower to the opposite side, i.e. against the direction of movement. The above-presented phases 8b to 8d follow each other until the desired new position of the processing device is reached.

The user of the processing device can, if desired, change the direction and speed of movement of the device while the processing device is moving. Thus; if necessary, the control unit calculates new control commands according to the new, desired direction.

As disclosed above, the processing device for mineral material comprises a frame and at least one processing unit, for example, a feeder, a belt conveyor, a crusher or a screen. It is also possible to use a device combination in processing material, which combination comprises several transferable processing devices. This kind of a combination could be, for example, a separate device composed of a feeder, a crusher and a conveyor, as well as a separate device composed of a screen and conveyors, which are placed in relation to each other so that the crushed material from the crusher is fed directly to the screen. Both these processing devices can be equipped with legs and they can be moved in the working site from one place to another as one entity. Thus, control means for moving several processing devices at the same time and to the same direction are formed in the control unit. This can be implemented, for example, so that the coordinates of different processing devices are locked to each other so that by controlling one processing device the other one will follow in the same manner. The location of the devices in the working site is transmitted to the control unit by entering the location data of one device and then positioning the devices in relation to each other. The location of the devices can also be determined with a positioning system, such as a GPS system. Both devices can naturally be moved independently as well. In that case both units must have separate control means.

Legs can be used not only for transferring the processing device, but also for supporting it during a work phase. In FIG. 1 the processing device is shown in a working position, where the device is lowered to the ground supported by the frame. The legs are also in contact with the ground, in which case they support the device. If there are potholes in the base, the length of the legs is adjusted so that the device is in balance.

The frame 6, to which the legs 7 are attached, can also be utilized in moving such processing devices or units that do not themselves comprise means for moving the device, such as tracks or wheels. Such a frame is disclosed, for example, in FIGS. 8a to 8d. The frame 6 is brought next to the processing device by means of the legs 7, after which the processing device is moved onto the frame and attached to it. After this the combination of the frame and processing device is moved to the desired position in the working site and the processing device is again detached from the frame and lowered to the ground. Then, the control unit is placed in the frame.

The invention is not intended to be limited to the embodiments presented as examples above, but the invention is intended to be applied widely within the scope of the inventive idea as defined in the appended claims.

1-31. (canceled)

32. A method for moving a processing device on a base, e.g. the ground, the processing device comprising:
at least one processing unit for processing mineral material;
a frame to which the processing unit is attached;
at least four legs articulated to the frame for moving the processing device, wherein each leg comprises a support plate settable against the base, and wherein each leg is settable into a support phase and a transfer phase, in which support phase the support plate sets against the base and in which transfer phase the support plate is off the base; and
a control unit for controlling the legs;
wherein the method comprises:
moving the processing device on the base by means of the legs without lowering the frame onto the base;
controlling each leg to settle to the support phase and the transfer phase alternately so that at least three of the legs are in the support phase during the movement of the processing device.

33. The method according to claim 32, wherein the method further comprises:
moving the processing device in a desired direction of movement by the legs in the support phase.

34. The method according to claim 32, wherein the method further comprises:
controlling the legs to settle alternately to a supporting and transfer phase in groups comprising one or more legs.

35. The method according to claim 32, wherein the leg comprises:
a first transfer member;
a second transfer member and a third transfer member, wherein the second transfer member and the third transfer member are articulated to the frame and the first transfer member;
wherein the method further comprises:
adjusting the length of the leg by the first transfer member.

36. The method according to claim 35, wherein the method further comprises:
controlling the legs in the supporting and transfer phase continuously with the control unit defining control signals for the first, the second and the third transfer member.

37. The method according to claim 35, wherein the method further comprises:
measuring the angular position between the first transfer member and the frame;
measuring the vertical position of the support plate; and
determining the position of the support plate in relation to the frame on the basis of the measurements.

38. The method according to claim 32, wherein the method further comprises:
monitoring the contact of the leg with the base by means of determining the pressure caused by the support plate against the base.

39. The method according to claim 35, wherein, for defining the control signals, at least one of the following parameters is used:
the position of the support plate in relation to the frame,
the pressure caused by the support plate against the base,
a walking mode,
the direction of movement of the processing device, and
the speed of movement of the processing device.

40. The method according to claim 32, wherein the processing unit is at least one of the following: a feeder, a crusher, a screen, a shredder, or a separator.

41. The method according to claim 40, wherein the processing device is a processing device for mineral material.

42. The method according to claim 32, wherein the method further comprises:
rotating, by means of the legs, the processing device around a freely selectable point.

43. The method according to claim 32, wherein the leg further comprises:
a hydraulic cylinder for adjusting the length of the leg; and
a pressure sensor for measuring the pressure prevailing in the hydraulic cylinder;
wherein the method further comprises:
determining, on the basis of the pressure in the hydraulic cylinter, the pressure caused by the support plate against the base.

44. A processing device, comprising:
a frame;
at least one processing unit for processing mineral material, wherein the processing unit is attached to the frame;
at least four legs articulated to the frame for moving the processing device without lowering the frame onto a base, e.g. the ground, wherein each leg comprises a support plate settable against the base, and wherein each leg is settable into a support phase and a transfer phase, in which support phase the support plate sets against the base and in which transfer phase the support plate is off the base; and
a control unit for controlling the legs, wherein the control unit is configured to control each leg to settle to the support phase and the transfer phase alternately so that at least three legs are in the support phase when moving the processing device.

45. The processing device according to claim 44, wherein the processing device is adapted to be moved in a desired direction of movement by the legs in the support phase.

46. The processing device according to claim 44, wherein the control unit is configured to control the legs to settle alternately to a supporting and transfer phase in groups comprising one or more legs.

47. The processing device according to claim 44, wherein the leg comprises a first transfer member configured to adjust the length of the leg.

48. The processing device according to claim 47, wherein the leg further comprises a second transfer member and a third transfer member, wherein the second transfer member and the third transfer member are articulated to the frame and the first transfer member.

49. The processing device according to claim 48, wherein the control unit is configured to define control signals for the first, second and third transfer members.

50. The processing device according to claim 49, wherein the leg further comprises:
measuring means for measuring the angular position between the first transfer member and the frame, and the vertical position of the support plate;
wherein the control unit is configured to determine the position of the support plate by means of the measurements.

51. The processing device according to claim 50, wherein the control unit is configured to determine the pressure caused by the support plate against the base.

52. The processing device according to claim 49, wherein the control unit is further configured to use at least one of the following parameters for defining control signals:
the position of the support plate,
the pressure caused by the support plate against the base,
a walking mode,
the direction of movement of the processing device, and
the speed of movement of the processing device.

53. The processing device according to claim 44, wherein the processing unit is at least one of the following: a feeder, a crusher, a screen, a shredder, or a separator.

54. The processing device according to claim 44, wherein the control unit is further configured to monitor the contact of the leg with the base by means of determining the pressure caused by the support plate against the base.

55. A frame of a processing device, wherein the frame comprises:
at least four legs articulated to the frame for moving the processing device without lowering it onto a base, e.g. the ground, wherein each leg comprises a supporting plate settable against the base, and wherein each leg is settable into a support phase and a transfer phase, in which support phase the support plate sets against the base and in which transfer phase the support surface of the support plate is off the base, and each leg is arranged to settle to the support phase and the transfer phase alternately so that at least three of the legs are in the support phase during the movement of the processing device;
wherein the processing device is for processing mineral material.

56. The frame according to claim 55, wherein the processing device, separate from the frame, comprises at least one processing unit for processing mineral material, wherein the processing device is configured to be moved on top of the frame and to be attached to the frame.

57. The frame according to claim 55, wherein the frame is a fixed part of the processing device, and wherein the processing device comprises at least one processing unit for processing mineral material.

58. The frame according to claim 55, wherein the frame is arranged to be moved in a desired direction of movement by means of the legs in the support phase.

59. The frame according to claim 55, wherein the leg comprises a first transfer member configured to adjust the length of the leg.

60. The frame according to claim 59, wherein the leg further comprises a second transfer member and a third transfer member, wherein the second transfer member and the third transfer member are articulated to the frame and the first transfer member.

61. The frame according to claim 55, wherein the frame further comprises:
a control unit arranged in connection with the frame and configured to control the legs, wherein the control unit is further configured to monitor the contact of the leg with the base by means of determining the pressure caused by the support plate against the base.

62. The frame according to claim 55, wherein the leg comprises:
a hydraulic cylinder for adjusting the length of the leg; and
a pressure sensor for measuring the pressure prevailing in the hydraulic cylinder and for determining the pressure caused by the support plate against the base.
